(19) United States
(12) Patent Application Publication
(10) Pub. No.: US 2019/0230506 A1
(43) Pub. Date: Jul. 25, 2019

(54) DIGITAL IDENTITY VERIFICATION SYSTEM

(71) Applicant: Zeeshan Malik, JR., Spring, TX (US)

(72) Inventor: Zeeshan Malik, JR., Spring, TX (US)

(21) Appl. No.: 16/126,141

(22) Filed: Sep. 10, 2018

Related U.S. Application Data
(63) Continuation-in-part of application No. 15/680,183, filed on Aug. 17, 2017.
(60) Provisional application No. 62/376,277, filed on Aug. 17, 2016.

(51) Int. Cl. H04W 12/06; H04W 12/00; G06Q 20/40

(52) U.S. Cl. CPC H04W 12/06; G06Q 20/4014; H04W 12/00407

(57) ABSTRACT

A system of validating a user's identity and available services through associated biometric features with the services. The services are verified through interfaces. The interface in able to read a variety of potential security parameters such as retina scanners, fingerprint readers, magnetic strips readers, cameras or the like.

### BACKGROUND

### 1. Field of the Invention

The present invention relates generally to identity verification systems, and more specifically, to a digital identity verification system for providing sensitive personal information to legitimate parties.

### 2. Description of Related Art

Identity verification systems are well known in the art and are effective means to demonstrate that an individual is who they purport to be. For example, FIG. 1 depicts a conventional identity verification system 101 having a user 103, with a credit card 105 from a bank 107, and a retailer 109. During use, the bank 107 through their proprietary processes issues card 105 to the user 103 who can in turn present it at retailer 109 to authorize their purchase.

One of the problems commonly associated with system 101 is its limited use. For example, the cards must be carried by the user to access the benefits, rendering unavailable the desired services should the card become lost or stolen.

Accordingly, although great strides have been made in the area of identity verification systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common identity verification system;

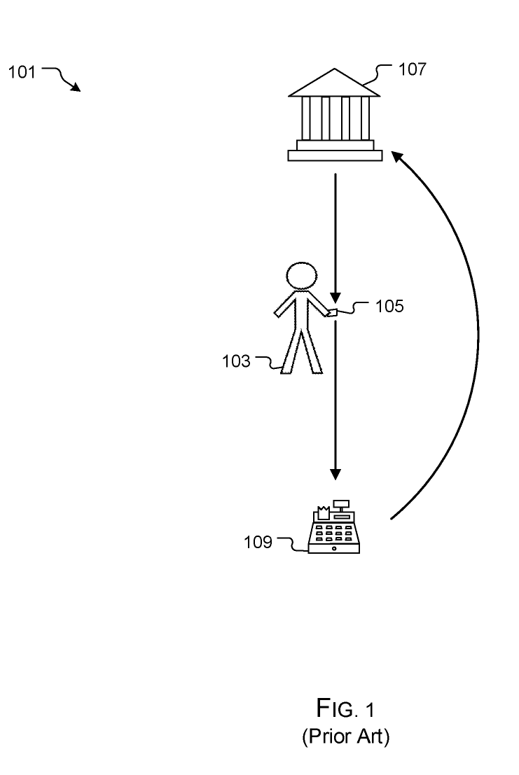

FIG. 2 is a diagram of a novel digital identity verification system in accordance with a preferred embodiment of the present application;

FIG. 3 is a diagram of the process of the system of FIG. 2;

FIG. 4 is a schematic of the interface of FIG. 2; and

FIG. 5 is a schematic of an alternative embodiment of the interface of FIG. 4.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional digital identity verification systems. Specifically, the system of the present application enables a user to directly provide verification of personal information without the need to associate this information with an identification device. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

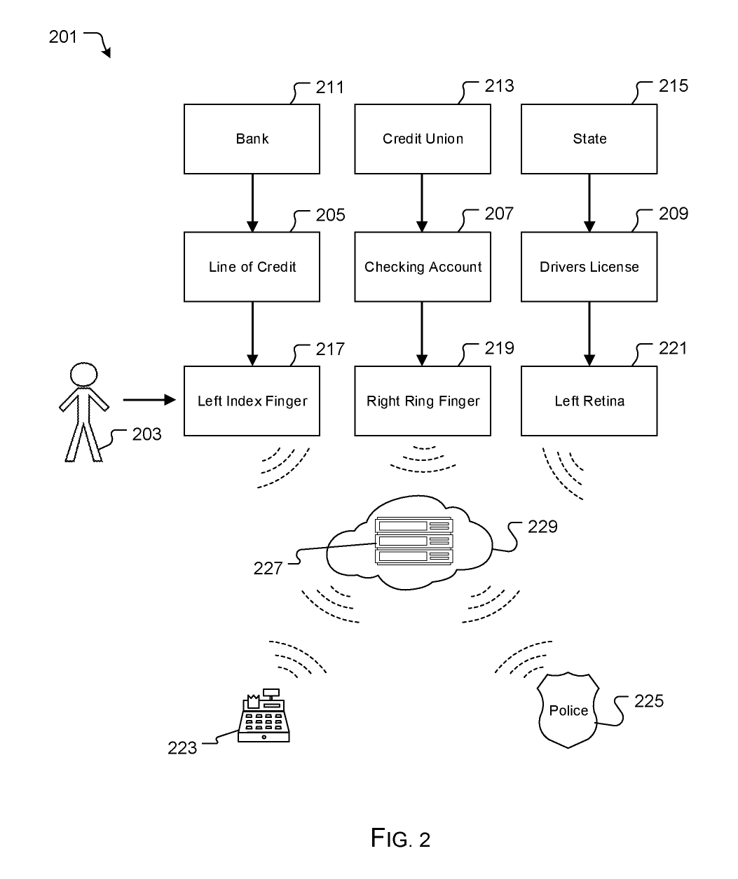

Referring now to the drawings wherein like reference characters identify corresponding or similar elements throughout the several views, FIG. 2 depicts a diagram of a digital identity verification system 201 in accordance with a preferred embodiment of the present application. It will be appreciated that system 201 overcomes one or more of the above-listed problems commonly associated with conventional identity verification systems.

In the contemplated embodiment, system 201 includes services 205, 207, 209 that are each connected to a unique biometric feature 217, 219, 221 respectively.

A user 203 that obtains services 205, 207, 209 from a source organization 211, 213, 215 that controls their respective service 205, 207, 209.

The biometric features 217, 219, 221 of a user 203 such as an index finger, ring finger, retina or the like are associated with the service 205, 207, 209 via an interface 227. It is contemplated that a single feature 217, 219, 221 or a combination of features 217, 219, 221 could be associated with a service 205, 207, 209.

A plurality of recipients 223, 225 access the services 205, 207, 209 via the associated biometric feature 217, 219, 221. The recipients 223, 225 could be commercial, private or public entities such as a store or the local police. The user 203, organizations 211, 213, 215, and recipients 223, 225 are in communication via interface 227 and one or more networks 229.

In use services 205, 207, 209 are created by the organizations 211, 213, 215 and given to the user 203. The user 203 links biometric features 217, 219, 221 to the desired service 205, 207, 209 via interface 227. The user 203 presents the appropriate biometric feature 217, 219, 221 to the requesting recipients 223, 225 to access the service 205, 207, 209. The recipients verify that user 203 has the service 205, 207, 209 via the interface 227. The interface communicates with the organizations 211, 213, 215 when their respective service 205, 207, 209 has been accessed by user 203. Although specific services, organizations, and biometric features are shown, it is contemplated and will be appreciated that any services, organizations, and biometric features can be used herein so long as they enable a user-specific means of identification as described herein.

It should be appreciated that one of the unique features believed characteristic of the present application is the direct association of services 205, 207, 209 to biometric features 217, 219, 221. The direct association reduces opportunities of use of the services 205, 207, 209 by anyone other than the user 203.

It will be appreciated that the biometric features 217, 219, 221, could be used in combination such as linking both the right index and pointer fingers to a service 205, 207, 209 and that both would need to be provided in the correct sequence to access the service. It is also contemplated and will be appreciated that security features such as a pin could be used in conjunction with the biometric features 215, 217, 221.

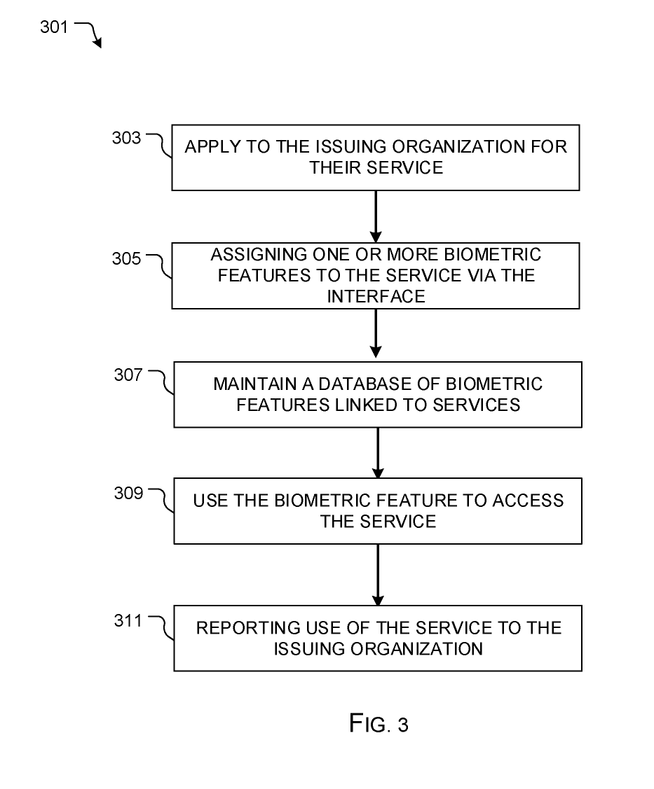

Referring now to FIG. 3 a method of use of the system of the present application is depicted, the method 301 including applying to the issuing organization for their service/benefit 303, assigning one or more biometric features to the service/benefit via one or more interfaces 305, maintaining a database of biometric features linked to services/benefits by the interface 307, using the biometric feature to access the service/benefit 309 and reporting the use of the service to the issuing organization 311.

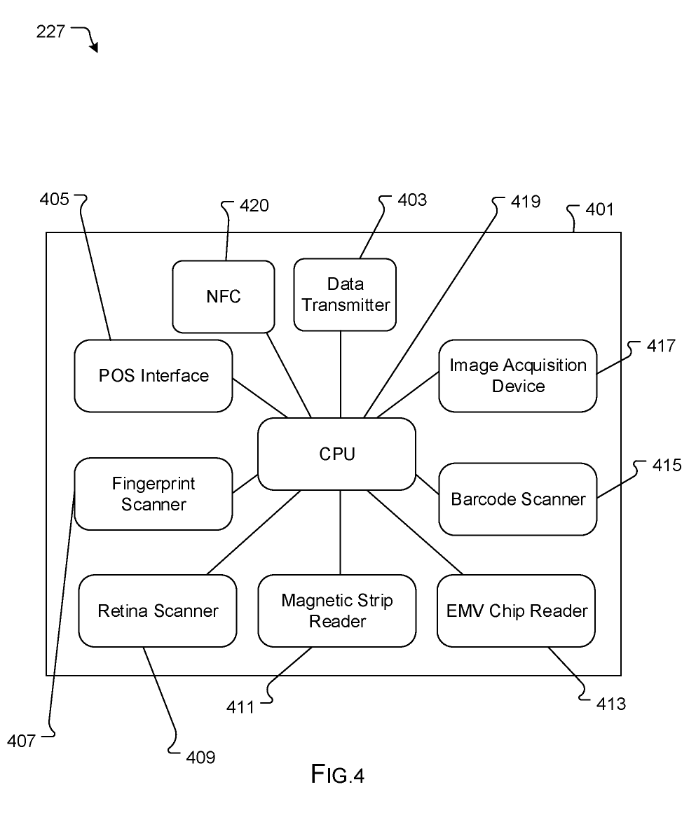

Referring now to FIG. 4 the interface 227 of system 201 is depicted, interface 227 comprising one or more housings 401 in communication with one or more data transmitter 403, one or more point of sale interfaces 405, one or more fingerprint scanners 407, one or more retina scanners 409, one or more magnetic strip readers 411, one or more EMV chip readers 413, one or more barcode scanners 415 and one or more image acquisition device 417 that are all in digital communication with one or more CPU devices 419. Further, the interface 227 can include a near field communications chip 420 allowing for pay by phone (or other computing device) features, as well as any other technology achieved via conventional NFC communication.

It will be appreciated that interface 227 is configured to validate the services 205, 207, 209. It is contemplated that interface 227 with this configuration could function as a standalone home system, and function in concert with a home computing device as well as in commercial settings. It is also anticipated that interface 227 could function wherever it is needed to validate services 205, 207, 209.

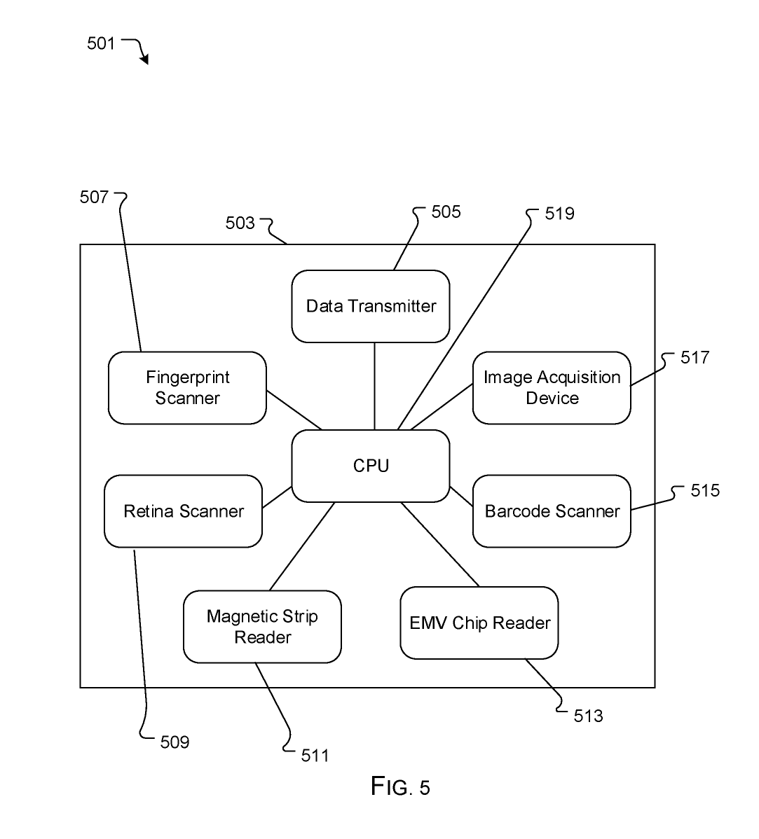

Referring now to FIG. 5 an alternative embodiment of the interface 227 of system 201 is depicted. Interface 501 including a 503 enclosing a data transmitter 505, a fingerprint scanner 507, a retina scanner 509, a magnetic strip reader 511, an EMV chip reader 513, a barcode scanner 515 and an image acquisition device 517 that are all in electronic communication with a CPU device 519.

It will be appreciated that interface 501 is configured to validate the services 205, 207, 209. It is contemplated that interface 501 with this configuration could function in public settings such as healthcare facilities or policing activities. It is also anticipated that interface 501 could function wherever it is needed to validate services 205, 207, 209.

It should be appreciated that the system and methods discussed herein can be used with computing devices of various forms, such as cell phones and the like.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A digital identity verification system, comprising:
a housing configured to be manipulated by the user and having an interface included therein, the interface having:
a device configured to detect an identity of the user;
a CPU in digital communication with the device;
a nearfield communication chip in communication with the CPU and configured to wirelessly communicate with other electronic devices; and
wherein the interface is configured to communicate with a database to authenticate the use of at least one service.

2. The apparatus of claim 1, wherein the device configured to detect the identity of the user is selected from one or more of:
a fingerprint scanner;
a point of sale interface;
a retina scanner;
a magnetic strip reader;
an EMV chip reader;
a barcode scanner; and
an image acquisition device.

3. A method of validating an identity of a user, the method comprising:
signing up for a first service with a first service provider;
associating an identity feature of the user with the first service;
providing a device configured to detect the identity feature; and
verifying the identity feature of the user via the device to complete a transaction.

4. The method of claim 3, further comprising:
signing up for a second service with a second service provider;
associating a second identity feature of the user with the second service;
providing a second device configured to detect the second identity feature; and
verifying the second identity feature of the user via the second device.

5. The method of claim 3, wherein the device is selected from one or more of:
a fingerprint scanner;
a point of sale interface;
a retina scanner;
a magnetic strip reader;
an EMV chip reader;
a barcode scanner; and
an image acquisition device.
